(19) United States
(12) Patent Application Publication
(10) Pub. No.: US 2026/0208867 A1
(43) Pub. Date: Jul. 23, 2026

(54) COMPOSITE WING CARBON NANOTUBE (CNT) ICE PROTECTION

(71) Applicant: Goodrich Corporation, Charlotte, NC (US)

(72) Inventors: Nathaniel Ching, Hartville, OH (US); Jin Hu, Cary, NC (US); Galdemir C. Botura, Copley, OH (US); Mateusz Pawlucki, Wroclaw (PL); Robinson Serre, Toulouse (FR); Pawel Jerzy Swirniak, Wroclaw (PL); Mithun Ravichandran, Toulouse (FR); Steven Kestler, San Diego, CA (US)

(73) Assignee: Goodrich Corporation, Charlotte, NC (US)

(21) Appl. No.: 19/451,727

(22) Filed: Jan. 16, 2026

Related U.S. Application Data
(60) Provisional application No. 63/747,489, filed on Jan. 21, 2025.

(51) Int. Cl. B64D 15/16; B32B 5/02; B32B 5/26; B32B 9/04; B32B 27/28

(52) U.S. Cl. CPC B64D 15/16; B32B 5/02; B32B 5/26; B32B 9/048; B32B 27/288; B32B 2250/05; B32B 2260/021; B32B 2260/046; B32B 2262/101; B32B 2262/106; B32B 2307/7376; B32B 2605/18

(57) ABSTRACT

A carbon nanotube (CNT) ice protection structure. The CNT ice protection structure including a carbon fiber composite layer, a first dielectric fiberglass layer, a CNT heater layer, a second dielectric fiberglass layer, and an erosion shield. A first side of the first dielectric fiberglass layer is bonded to the carbon fiber composite layer. A first side of the CNT layer is coupled to a second side of the first dielectric fiberglass layer. A first side of the second dielectric fiberglass layer bonded to a second side of the CNT layer. The erosion shield coupled to a second side of the second dielectric fiberglass layer.

### CROSS-REFERENCE TO RELATED APPLICATIONS

This application claims priority to and the benefit of, U.S. Provisional Application No. 63/747,489, filed Jan. 21, 2025, and entitled “COMPOSITE WING CARBON NANOTUBE (CNT) ICE PROTECTION,” which is incorporated by reference herein in its entirety for all purposes.

### FIELD

The present disclosure generally relates to resistive heating systems, and more specifically, to composite wing carbon nanotube (CNT) ice protection.

### BACKGROUND

Composite wings and other aircraft leading edges are lightweight but require ice protection systems that can remove ice without overheating the structure. Additionally, composite materials are not as capable of withstanding erosion as metallic materials.

### SUMMARY

A carbon nanotube (CNT) ice protection structure is disclosed herein. The CNT ice protection structure includes a carbon fiber composite layer, a first dielectric fiberglass layer, a CNT heater layer, a second dielectric fiberglass layer, and an erosion shield. A first side of the first dielectric fiberglass layer is bonded to the carbon fiber composite layer. A first side of the CNT layer is bonded to a second side of the first dielectric fiberglass layer. A first side of the second dielectric fiberglass layer is bonded to a second side of the CNT layer. The erosion shield is coupled to a second side of the second dielectric fiberglass layer.

In various embodiments, the carbon fiber composite layer is between 0.030 inches (0.0762 centimeters) to 0.140 inches (0.3556 centimeters) thick.

In various embodiments, the carbon fiber composite layer includes carbon fibers and a resin. In various embodiments, the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

In various embodiments, the first dielectric fiberglass layer is between 0.005 inches (0.0127 centimeters) to 0.020 inches (0.0508 centimeters) thick.

In various embodiments, the first dielectric fiberglass layer includes fiberglass and a resin. In various embodiments, resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

In various embodiments, the CNT heater layer includes a CNT heater and a resin. In various embodiments, the CNT heater is embedded within the resin. In various embodiments, the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

In various embodiments, the second dielectric fiberglass layer is between 0.005 inches (0.0127 centimeters) to 0.020 inches (0.0508 centimeters) thick.

In various embodiments, the second dielectric fiberglass layer includes fiberglass and a resin. In various embodiments, the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

In various embodiments, the erosion shield is between 0.003 inches (0.00762 centimeters) to 0.050 inches (0.127 centimeters) thick.

In various embodiments, the erosion shield is at least one of a metal or metal alloy. In various embodiments, the metal is nickel. In various embodiments, the metal alloy is nickel-cobalt.

Also disclosed herein is an aircraft. The aircraft includes a control surface and a carbon nanotube (CNT) ice protection structure coupled to the control surface. The CNT ice protection structure includes a carbon fiber composite layer, a first dielectric fiberglass layer, a CNT heater layer, a second dielectric fiberglass layer, and an erosion shield. A first side of the first dielectric fiberglass layer is bonded to the carbon fiber composite layer. A first side of the CNT layer is bonded to a second side of the first dielectric fiberglass layer. A first side of the second dielectric fiberglass layer is bonded to a second side of the CNT layer. The erosion shield is coupled to a second side of the second dielectric fiberglass layer.

In various embodiments, the carbon fiber composite layer is between 0.030 inches (0.0762 centimeters) to 0.140 inches (0.3556 centimeters) thick.

In various embodiments, the carbon fiber composite layer includes carbon fibers and a resin. In various embodiments, the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

In various embodiments, the first dielectric fiberglass layer is between 0.005 inches (0.0127 centimeters) to 0.020 inches (0.0508 centimeters) thick.

In various embodiments, the first dielectric fiberglass layer includes fiberglass and a resin. In various embodiments, resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

In various embodiments, the CNT heater layer includes a CNT heater and a resin. In various embodiments, the CNT heater is embedded within the resin. In various embodiments, the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

In various embodiments, the second dielectric fiberglass layer is between 0.005 inches (0.0127 centimeters) to 0.020 inches (0.0508 centimeters) thick.

In various embodiments, the second dielectric fiberglass layer includes fiberglass and a resin. In various embodiments, the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

In various embodiments, the erosion shield is between 0.003 inches (0.00762 centimeters) to 0.050 inches (0.127 centimeters) thick. In various embodiments, the erosion shield is at least one of a metal or metal alloy. In various embodiments, the metal is nickel. In various embodiments, the metal alloy is nickel-cobalt.

Also disclosed herein is a method of forming a carbon nanotube (CNT) ice protection structure. The method includes forming a carbon fiber composite layer; layering a first dielectric fiberglass layer on top of to the carbon fiber composite layer; layering a CNT heater layer on top of the first dielectric fiberglass layer; layering a second dielectric fiberglass layer on top of the CNT layer; consolidating the carbon fiber composite layer, the first dielectric fiberglass layer, the CNT heater layer, and the second dielectric fiberglass layer together thereby forming a consolidated structure; forming a leading edge from the consolidated structure; and applying an erosion shield to the leading edge, the erosion shield applied to the second dielectric fiberglass layer side of the leading edge.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft including a deicing assembly on the wings, in accordance with various embodiments.

FIG. 2 illustrates a carbon nanotube (CNT) ice protection structure coupled to a control surface, in accordance with various embodiments.

FIG. 3 illustrated a flow diagram for forming a multi-thermoplastic leading-edge ice protection structure, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Disclosed herein is a carbon nanotube (CNT) ice protection structure. In various embodiments, the CNT ice protection structure includes a carbon fiber composite layer including carbon fibers and a resin. In various embodiments, the thickness of the carbon fiber composite layer depends on the strength and impact requirements at that exact location on the aircraft. In various embodiments, the resin is from the polyaryletherketone family. In various embodiments, a first dielectric fiberglass layer is layered on the carbon fiber composite layer. In various embodiments, the first dielectric fiberglass layer includes fiberglass and a resin. In various embodiments, the resin is from the polyaryletherketone family. In various embodiments, a carbon nanotube (CNT) heater is layered on the first dielectric fiberglass layer. In various embodiments, the CNT heater is embedded within a resin. In various embodiments, the resin is from the polyaryletherketone family. In various embodiments, a second dielectric fiberglass layer is layered on the CNT heater. In various embodiments, the second dielectric fiberglass layer includes fiberglass and a resin. In various embodiments, a resin is from the polyaryletherketone family. In various embodiments, the various layers of the CNT ice protection structure are consolidated together and formed to a leading-edge shape. In various embodiments, the carbon nanotube (CNT) ice protection structure may be consolidated in a flat blank using heat and vacuum and/or pressure. In various embodiments, the flat blank is reheated and then stamp-formed into a leading edge.

In various embodiments, a metallic erosion shield is affixed onto the leading edge, i.e. on the second dielectric fiberglass layer. In various embodiments, the metallic erosion shield may include nickel or nickel-cobalt, among other metals or metal alloys. In various embodiments, a thickness of the metallic erosion shield depends on specific erosion requirements. In various embodiments, the metallic erosion shield is chemically deposited or electrodeposited on the second dielectric fiberglass layer to protect the composites from erosion. In various embodiments, the metallic erosion shield is chemically deposited or electrodeposited on the leading edge to the required thickness.

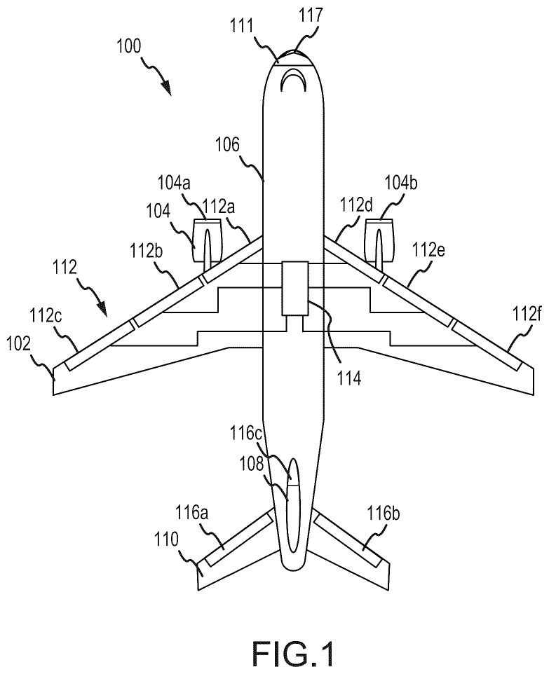

Referring now to FIG. 1, a top view of an aircraft 100 is illustrated, in accordance with various embodiments. Aircraft 100 includes wings 102, nacelles 104 around engines, a fuselage 106, a vertical stabilizer 108, horizontal stabilizers 110, and dome 111, among other control surfaces. Aircraft 100 further includes a plurality of de-icing assemblies 112 including de-icing assemblies 112a, 112b, 112c on a first wing 102, de-icing assemblies 112d, 112e, 112f on a second wing 102, de-icing assemblies 104a and 104b on nacelles 104, de-icing assemblies 116c on vertical stabilizer 108, de-icing assemblies 116a and 116b on horizontal stabilizers 110, and de-icing assembly 117 on dome 111. In various embodiments, de-icing assemblies 112a-f may be located on a leading edge of each wing 102 (as illustrated in FIG. 1), de-icing assemblies 104a and 104b may be located on engine inlets of each nacelles 104, de-icing assemblies 116c may be located on a leading edge of vertical stabilizer 108, de-icing assemblies 116a and 116b may be located on a leading edge of horizontal stabilizers 110, and de-icing assembly 117 may be located on a leading edge of dome 111 to prevent the buildup of ice on the leading edges. In various embodiments, de-icing assemblies 112a, 112d may be located at a proximal end of wings 102 adjacent the fuselage 106, de-icing assemblies 112c, 112f may be located at a distal end of wings 102, and de-icing assemblies 112b, 112e may be located between de-icing assemblies 112a, 112d and de-icing assemblies 112c, 112f, respectively.

In various embodiments, de-icing assemblies 112 may be located on an external surface of wings 102, de-icing assemblies 104a and 104b may be located on an external surface of engine inlets of each engine 104, de-icing assemblies 116c may be located on an external surface of vertical stabilizer 108, de-icing assemblies 116a and 116b may be located on an external surface of horizontal stabilizers 110, de-icing assembly 117 may be located on an external surface of dome 111. For simplicity and ease of discussion, de-icing assemblies 112 will be described hereafter as being coupled to the leading edge of wings 102, though other locations are considered.

In various embodiments, each of the de-icing assemblies 112a-112f may be individually coupled to a controller 114. In various embodiments, controller 114 may comprise one or more processors configured to implement various logical operations in response to execution of instructions, for example, instructions stored on a non-transitory, tangible, computer-readable medium. The one or more processors can be a general-purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. In various embodiments, controller 114 may further comprise memory to store data, executable instructions, system program instructions, and/or controller instructions to implement the control logic of controller 114.

System program instructions and/or controller instructions may be loaded onto a non-transitory, tangible computer-readable medium having instructions stored thereon that, in response to execution by the controller 114, cause the controller 114 to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

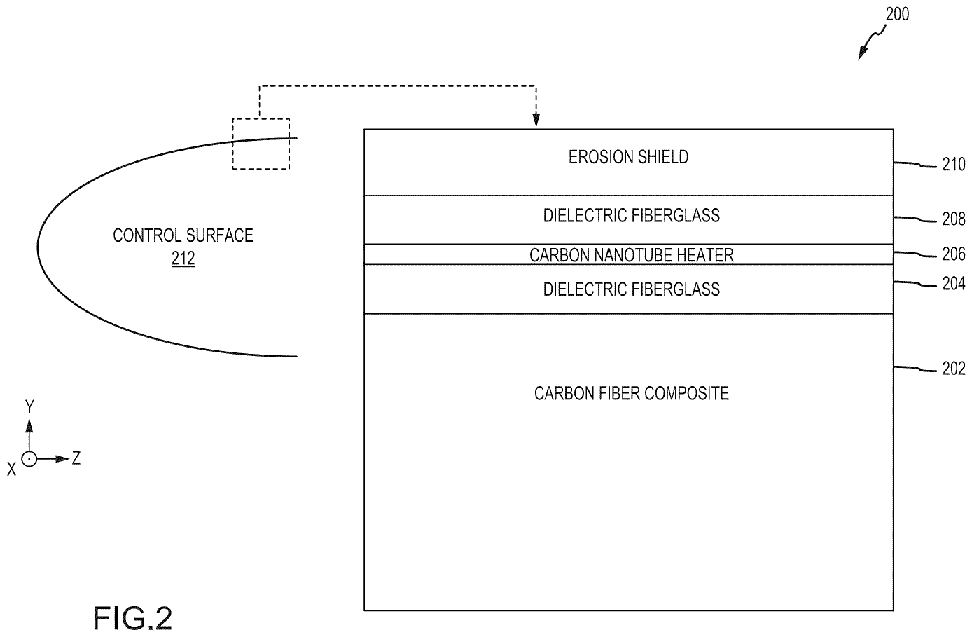

Referring now to FIG. 2, a carbon nanotube (CNT) ice protection structure 200 is illustrated, in accordance with various embodiments. In various embodiments, the CNT ice protection structure 200 includes a carbon fiber composite layer 202 including carbon fibers and a resin is formed on a surface, such as on a table or in a mold. In various embodiments, the carbon fiber composite layer 202 may be between 0.030 inches (0.0762 centimeters) to 0.140 inches (0.3556 centimeters) thick. In various embodiments, the thickness of the carbon fiber composite layer 202 depends on the strength and impact requirements at that exact location on the aircraft. In various embodiments, the resin is from the polyaryletherketone family including polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK), among others.

In various embodiments, a first dielectric fiberglass layer 204 including fiberglass and a resin is added on top of the carbon fiber composite layer 202. In various embodiments, the first dielectric fiberglass layer 204 may be between 0.005 inches (0.0127 centimeters) to 0.020 inches (0.0508 centimeters) thick. In various embodiments, the resin is from the polyaryletherketone family. In various embodiments, the resin is from the polyaryletherketone family including polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK), among others.

In various embodiments, a carbon nanotube (CNT) heater layer 206 is layered on top of the first dielectric fiberglass layer 204. In various embodiments, the CNT heater layer 206 is embedded within a resin. In various embodiments, the resin is from the polyaryletherketone family. In various embodiments, the resin is from the polyaryletherketone family. In various embodiments, the resin is from the polyaryletherketone family including polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK), among others.

In various embodiments, a second dielectric fiberglass layer 208 including fiberglass and a resin is added on top of the CNT heater layer 206. In various embodiments, the second dielectric fiberglass layer 208 may be between 0.005 inches (0.0127 centimeters) to 0.020 inches (0.0508 centimeters) thick. In various embodiments, a preferred resin is from the polyaryletherketone family. In various embodiments, the resin is from the polyaryletherketone family including polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK), among others.

In various embodiments, the various layers of the carbon nanotube (CNT) ice protection structure are consolidated together and formed to a leading-edge shape. In various embodiments, the consolidation may be in a vacuum or under pressure. In various embodiments, the pressure may be under pressure of between 10 pounds per square inch (PSI) and 1000 PSI. In various embodiments, the consolidation may be performed using heat. In various embodiments, the heat may be at a temperature ranging from between 400° C. to 900° C. depending on the resin(s) of the carbon fiber composite layer 202, the first dielectric fiberglass layer 204, the CNT heater layer 206, and the second dielectric fiberglass layer 208. In various embodiments, the consolidation may be performed for between 5 seconds and 2 hours. In various embodiments, the carbon nanotube (CNT) ice protection structure may be consolidated in a flat blank using the heat and the vacuum and/or the pressure. In various embodiments, once the consolidation is complete, the flat blank may be reheated and then stamp-formed into a leading edge. In various embodiments, the reheating may be at a temperature ranging from between 400° C. to 900° C. depending on the resin(s) of the carbon fiber composite layer 202, the first dielectric fiberglass layer 204, the CNT heater layer 206, and the second dielectric fiberglass layer 208 in order to make the leading edge flexible. In various embodiments, the reheating may be performed in a vacuum or under pressure. In various embodiments, the pressure may be under pressure of between 10 pounds per square inch (PSI) and 1000 PSI. In various embodiments, the reheating may be performed for between 5 seconds and 2 hours.

In various embodiments, once the leading edge is formed, a metallic erosion shield 210 may be applied to the leading edge, i.e. to the second dielectric fiberglass layer 208 side of the leading edge. In various embodiments, the metallic erosion shield 210 may be between 0.003 inches (0.00762 centimeters) to 0.050 inches (0.127 centimeters) thick. In various embodiments, the metallic erosion shield 210 may include nickel or nickel-cobalt, among other metals or metal alloys. In various embodiments, a thickness of the metallic erosion shield 210 depends on specific erosion characteristics. In various embodiments, the metallic erosion shield 210 is chemically deposited or electrodeposited on the second dielectric fiberglass layer 208 to protect the composites from erosion. In various embodiments, the metallic erosion shield 210 is chemically deposited or electrodeposited on the leading edge to the required thickness. In various embodiments, once the CNT ice protection structure 200 is shaped and has the metallic erosion shield applied 210, the CNT ice protection structure 200 may be affixed to the control surface 212.

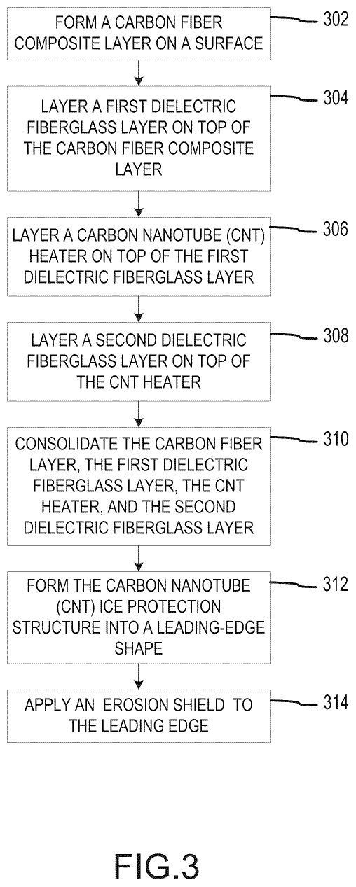

Referring to FIG. 3, in accordance with various embodiments, a flow diagram for forming a multi-thermoplastic leading-edge ice protection structure is illustrated. In various embodiments, at block 302, a carbon fiber composite layer is formed on a surface, such as on a table or in a mold. In various embodiments, at block 304, a first dielectric fiberglass layer is layered on top of the carbon fiber composite layer. In various embodiments, at block 306, a carbon nanotube (CNT) heater is layered on top of the first dielectric fiberglass layer. In various embodiments, at block 308, a second dielectric fiberglass layer is layered on top of the CNT heater. In various embodiments, at block 310, the various layers of the carbon nanotube (CNT) ice protection structure are consolidated together forming a consolidated structure. In various embodiments, once consolidated, at block 310, the carbon nanotube (CNT) ice protection structure is formed into a leading-edge shape from the consolidated structure. In various embodiments, at block 312, a metallic erosion shield is applied to the leading edge, i.e. to the second dielectric fiberglass layer side of the leading edge.

Accordingly, the carbon nanotube (CNT) heater is close to the outer surface while maintaining electrical safety and being mechanically protected. In various embodiments, the carbon nanotube (CNT) ice protection structure is consolidated together to increase interlaminar strength and decrease the possibility of the assembly coming apart under load.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A carbon nanotube (CNT) ice protection structure, comprising:
a carbon fiber composite layer;
a first dielectric fiberglass layer, a first side of the first dielectric fiberglass layer bonded to the carbon fiber composite layer;
a CNT heater layer, a first side of the CNT layer bonded to a second side of the first dielectric fiberglass layer;
a second dielectric fiberglass layer, a first side of the second dielectric fiberglass layer bonded to a second side of the CNT layer; and
an erosion shield, the erosion shield coupled to a second side of the second dielectric fiberglass layer.

2. The carbon nanotube (CNT) ice protection structure of claim 1, wherein the carbon fiber composite layer is between 0.030 inches (0.0762 centimeters) to 0.140 inches (0.3556 centimeters) thick.

3. The carbon nanotube (CNT) ice protection structure of claim 1, wherein the carbon fiber composite layer comprises:
carbon fibers; and
a resin, wherein the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

4. The carbon nanotube (CNT) ice protection structure of claim 1, wherein the first dielectric fiberglass layer is between 0.005 inches (0.0127 centimeters) to 0.020 inches (0.0508 centimeters) thick.

5. The carbon nanotube (CNT) ice protection structure of claim 1, wherein the first dielectric fiberglass layer comprises:
fiberglass; and
a resin, wherein the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

6. The carbon nanotube (CNT) ice protection structure of claim 1, wherein the CNT heater layer comprises:
a CNT heater; and
a resin, wherein the CNT heater is embedded within the resin and wherein the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

7. The carbon nanotube (CNT) ice protection structure of claim 1, wherein the second dielectric fiberglass layer is between 0.005 inches (0.0127 centimeters) to 0.020 inches (0.0508 centimeters) thick.

8. The carbon nanotube (CNT) ice protection structure of claim 1, wherein the second dielectric fiberglass layer comprises:
fiberglass; and
a resin, wherein the resin is at least one of polyetheretherketone (PEEK), polyetherketoneketone (PEKK), polyetherketone (PEK), polyetheretherketoneketone (PEEKK), polyetherketoneetherketoneketone (PEKEKK), or polyetherdiphenyletherketone (PEDEK).

9. The carbon nanotube (CNT) ice protection structure of claim 1, wherein the erosion shield is between 0.003 inches (0.00762 centimeters) to 0.050 inches (0.127 centimeters) thick.

10. The carbon nanotube (CNT) ice protection structure of claim 1, wherein the erosion shield is at least one of a metal or metal alloy, wherein the metal is nickel, and wherein the metal alloy is nickel-cobalt.

11. An aircraft comprising:
a control surface; and
a carbon nanotube (CNT) ice protection structure coupled to the control surface, the CNT ice protection structure comprising:
a carbon fiber composite layer;
a first dielectric fiberglass layer, a first side of the first dielectric fiberglass layer bonded to the carbon fiber composite layer;
a CNT heater layer, a first side of the CNT layer bonded to a second side of the first dielectric fiberglass layer;
a second dielectric fiberglass layer, a first side of the second dielectric fiberglass layer bonded to a second side of the CNT layer; and
an erosion shield, the erosion shield coupled to a second side of the second dielectric fiberglass layer.

12. The aircraft of claim 11, wherein the carbon fiber composite layer is between 0.030 inches (0.0762 centimeters) to 0.140 inches (0.3556 centimeters) thick.

13. The aircraft of claim 11, wherein the carbon fiber composite layer comprises:
carbon fibers; and
a resin, wherein the resin is at least one of Polyetheretherketone (PEEK), Polyetherketoneketone (PEKK), Polyetherketone (PEK), Polyetheretherketoneketone (PEEKK), Polyetherketoneetherketoneketone (PEKEKK), or polyetherdiphenyletherketone (PEDEK).

14. The aircraft of claim 11, wherein the first dielectric fiberglass layer is between 0.005 inches (0.0127 centimeters) to 0.020 inches (0.0508 centimeters) thick.

15. The aircraft of claim 11, wherein the first dielectric fiberglass layer comprises:
fiberglass; and
a resin, wherein the resin is at least one of Polyetheretherketone (PEEK), Polyetherketoneketone (PEKK), Polyetherketone (PEK), Polyetheretherketoneketone (PEEKK), Polyetherketoneetherketoneketone (PEKEKK), or polyetherdiphenyletherketone (PEDEK).

16. The aircraft of claim 11, wherein the CNT heater layer comprises:
a CNT heater; and
a resin, wherein the CNT heater is embedded within the resin and wherein the resin is at least one of Polyetheretherketone (PEEK), Polyetherketoneketone (PEKK), Polyetherketone (PEK), Polyetheretherketoneketone (PEEKK), Polyetherketoneetherketoneketone (PEKEKK), or polyetherdiphenyletherketone (PEDEK).

17. The aircraft of claim 11, wherein the second dielectric fiberglass layer is between 0.005 inches (0.0127 centimeters) to 0.020 inches (0.0508 centimeters) thick.

18. The aircraft of claim 11, wherein the second dielectric fiberglass layer comprises:
fiberglass; and
a resin, wherein the resin is at least one of Polyetheretherketone (PEEK), Polyetherketoneketone (PEKK), Polyetherketone (PEK), Polyetheretherketoneketone (PEEKK), Polyetherketoneetherketoneketone (PEKEKK), or polyetherdiphenyletherketone (PEDEK).

19. The aircraft of claim 11, wherein the erosion shield is between 0.003 inches (0.00762 centimeters) to 0.050 inches (0.127 centimeters) thick, wherein the erosion shield is at least one of a metal or metal alloy, wherein the metal is nickel, and wherein the metal alloy is nickel-cobalt.

20. A method of forming a carbon nanotube (CNT) ice protection structure comprising:
forming a carbon fiber composite layer;
layering a first dielectric fiberglass layer on top of to the carbon fiber composite layer;
layering a CNT heater layer on top of the first dielectric fiberglass layer;
layering a second dielectric fiberglass layer on top of the CNT layer;
consolidating the carbon fiber composite layer, the first dielectric fiberglass layer, the CNT heater layer, and the second dielectric fiberglass layer together thereby forming a consolidated structure;
forming a leading edge from the consolidated structure; and
applying an erosion shield to the leading edge, the erosion shield applied to the second dielectric fiberglass layer side of the leading edge.
